(19) United States
(12) Patent Application Publication
(10) Pub. No.: US 2017/0174124 A1
(43) Pub. Date: Jun. 22, 2017

(54) ILLUMINATED VEHICLE PANEL

(71) Applicant: Ford Global Technologies, LLC, Dearborn, MI (US)

(72) Inventors: Stuart C. Salter, White Lake, MI (US); James J. Surman, Clinton Township, MI (US); Cornel Lewis Gardner, Romulus, MI (US); Peter Joseph Bejin, Northville, MI (US)

(73) Assignee: Ford Global Technologies, LLC

(21) Appl. No.: 14/971,017

(22) Filed: Dec. 16, 2015

(51) Int. Cl. B60Q 3/02

(52) U.S. Cl. CPC B60Q 3/0243; F21K 9/64

(57) ABSTRACT

A vehicle is provided that includes a panel. The panel includes a substrate defining a first surface and a second surface disposed on opposite sides thereof, a phosphorescent structure positioned on the first surface of the substrate, and a photoluminescent structure positioned on the second surface of the substrate. A light-producing assembly is positioned to illuminate the second surface of the substrate.

### FIELD OF THE INVENTION

The present invention generally relates to vehicle lighting systems, and more particularly, to vehicle lighting systems employing photoluminescent and phospholuminescent structures.

### BACKGROUND OF THE INVENTION

Illumination arising from the use of photoluminescent structures offers a unique and attractive viewing experience. It is therefore desired to implement such structures in automotive vehicles for various lighting applications.

### SUMMARY OF THE INVENTION

According to one aspect of the present invention, a vehicle is provided that includes a panel. The panel includes a substrate defining a first surface and a second surface disposed on opposite sides thereof, a phosphorescent structure positioned on the first surface of the substrate, and a photoluminescent structure positioned on the second surface of the substrate. A light-producing assembly is positioned to illuminate the second surface of the substrate.

According to another aspect of the present invention, a vehicle is provided that includes a vehicle interior panel. The vehicle interior panel includes a substrate defining an A-surface and a B-surface disposed on opposite sides thereof. A photoluminescent structure is positioned on the B-surface of the substrate. A light-producing assembly is positioned proximate the B-surface of the substrate. The light-producing assembly is configured to emit light toward the photoluminescent structure.

According to yet another aspect of the present invention, a vehicle is provided that includes an interior panel with a substrate. The substrate includes at least one substantially translucent portion and a light-producing assembly positioned outboard of the interior panel. The light-producing assembly is configured to emit light toward an outboard surface of the substrate.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a perspective view of a door of a vehicle shown in an open position, according to one embodiment;

FIG. 2 is an enlarged cross-sectional view of a panel depicted and taken along line II-II of FIG. 1, according to one embodiment;

FIG. 3A is an enlarged view of section IIIA of FIG. 2, according to one embodiment;

FIG. 3B is an enlarged view of section IIIB of FIG. 2, according to one embodiment;

FIG. 3C is an enlarged view of section IIIC of FIG. 2, according to one embodiment;

FIG. 3D is an enlarged view of section IIID of FIG. 2, according to one embodiment;

FIG. 3E is an enlarged view of section IIIE of FIG. 2, according to one embodiment; and

FIG. 4 is a block diagram further illustrating the panel, according to one embodiment.

### DETAILED DESCRIPTION OF THE PREFERRED EMBODIMENTS

As required, detailed embodiments of the present invention are disclosed herein. However, it is to be understood that the disclosed embodiments are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

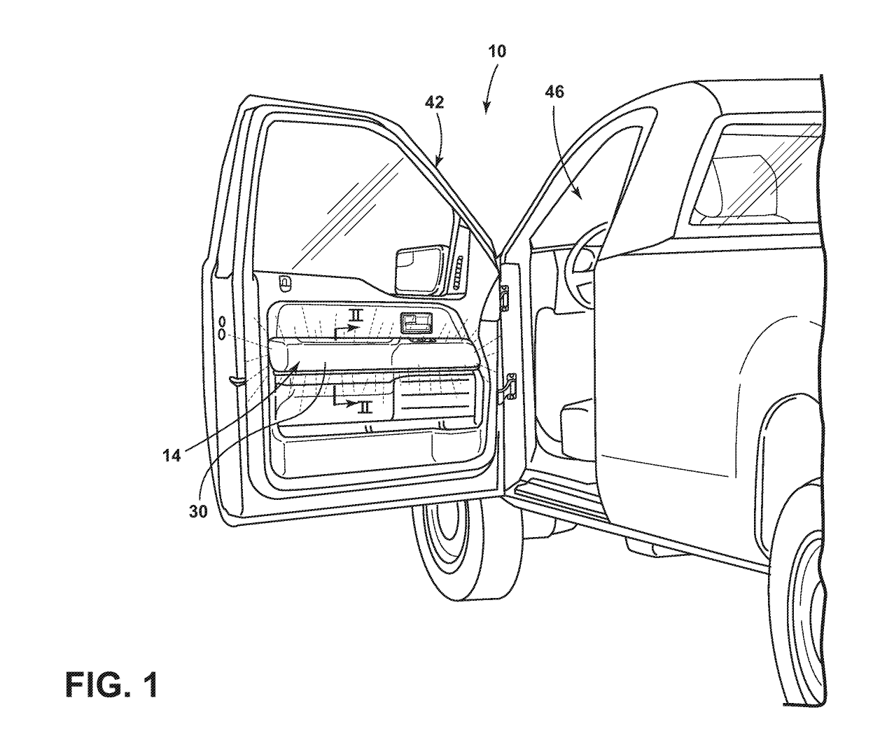

Referring now to FIGS. 1-4, a vehicle 10 is depicted including a panel 14 which includes a substrate 18 defining an A-surface 22 and a B-surface 26 disposed on opposite sides thereof. A phosphorescent structure 30 is positioned on the A-surface 22 of the substrate 18. A photoluminescent structure 34 is positioned on the B-surface 26 of the substrate 18. A light-producing assembly 38 is positioned proximate the B-surface 26 of the substrate 18.

Referring now to FIG. 1, the vehicle 10 is generally shown having a door 42 which facilitates ingress to, and egress from, an interior 46 of the vehicle 10. Positioned on the door 42 is the panel 14. It will be understood that the panel 14, as described below, may be equally utilized in other areas within the interior 46 of the vehicle 10. For example, the panel 14 may form a portion of, or all of, the instrument panel, ceiling, A or B-pillars, flooring, seating, center console, handles, steering wheel, walls, storage trays and/or glove box. It will also be understood that the disclosure may equally be applied to exterior components of the vehicle 10 such as bumpers, exterior panels, light assemblies (e.g., headlights and tail lights) fenders, etc. without departing from the spirit of this disclosure. The panel 14 may be configured to emit light (e.g., backlit and/or frontlit) and provide illumination to the interior 46 and/or exterior of the vehicle 10. The panel 14 may be configured as a large panel covering an interior of the door 42, as a thin strip, and various sizes in between. Further, the panel 14 may be configured as a molding or trim component for the interior 46 or exterior of the vehicle 10.

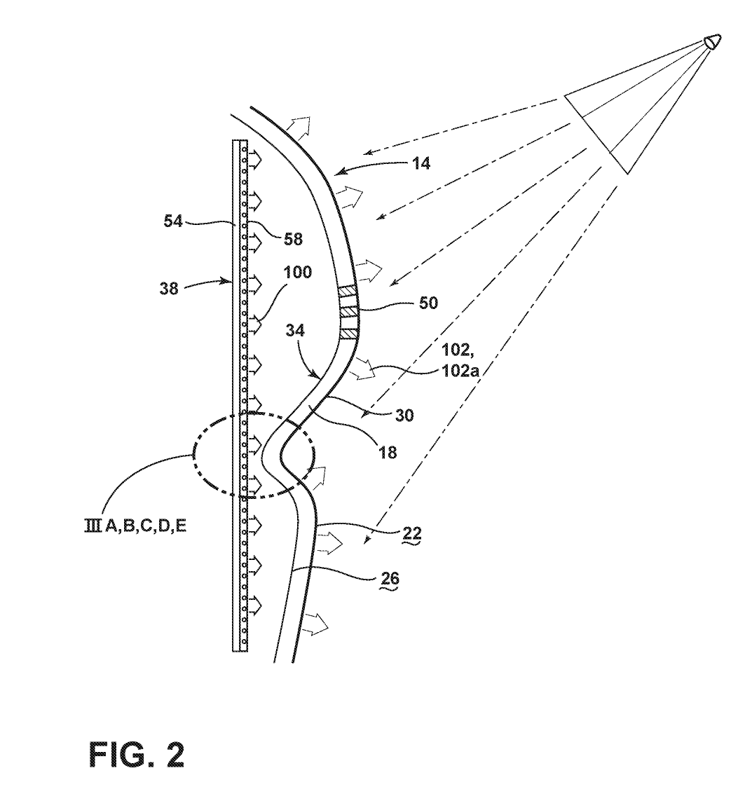

Referring now to the depicted embodiment of FIG. 2, the panel 14 is a multi-layer structure configured to be both backlit and frontlit. The panel 14 includes the substrate 18 which defines the A-surface 22, which is generally defined on a vehicle inboard side of the substrate 18, and the B-surface 26, which is generally defined on a vehicle outboard side of the substrate 18. Stated another way, the A-surface 22 is the surface typically viewed by a passenger of the vehicle 10 and the B-surface 26 is not typically viewed by the passenger. The A-surface 22 and the B-surface 26 are defined on opposite sides of the substrate 18. The phosphorescent structure 30 is positioned on the A-surface 22 of the substrate 18. The phosphorescent structure 30 is positioned on the A-surface 22 such that illumination from the sun or other light sources may fall on the phosphorescent structure 30 and thereby charge the phosphorescent structure 30. The phosphorescent structure 30 is configured to provide the panel 14 with frontlit illumination. The photoluminescent structure 34 is positioned on the B-surface 26, or outboard side of the substrate 18, proximate the light-producing assembly 38. The photoluminescent structure 34 is configured to cooperate with the light-producing assembly 38 to provide the panel 14 with backlit illumination. The substrate 18 may be composed of a polymeric material, a metal, and/or composite material. The substrate 18 may define one or more translucent or transparent portions, and in some embodiments, may be entirely translucent and/or transparent. In some embodiments, the translucent and/or transparent portions of the panel 14 may form a pattern or aesthetically pleasing design. The phosphorescent and photoluminescent structures 30, 34 may be partially or fully disposed over the transparent portions. In some embodiments, the substrate 18, photoluminescent structure 34, and/or phosphorescent structure 30 may include or define indicia 50. The indicia 50 may be a sign, design, emblem, text, picture or other visual symbol. The indicia 50 may be a lack of photoluminescent structure 34 and/or phosphorescent structure 30 and/or an opaque portion of the substrate 18 and/or an opaque dye or coloring such that an illumination discontinuity or change in color of illumination is used to form an image in the illumination of the panel 14. Additionally or alternatively, the indicia 50 may be formed of another material (e.g., vacuumized metal).

The panel 14 is generally disposed between the light-producing assembly 38 and the interior 46 such that the panel 14 is disposed inboard on the vehicle 10 relative to the light-producing assembly 38. In the depicted embodiment, the light-producing assembly 38 may include a printed circuit board (PCB) 54 on which a light source 58 is disposed. The light-producing assembly 38 is positioned remotely from the panel 14, which may allow light from the light-producing assembly 38 to more evenly fall on the photoluminescent structure 34.

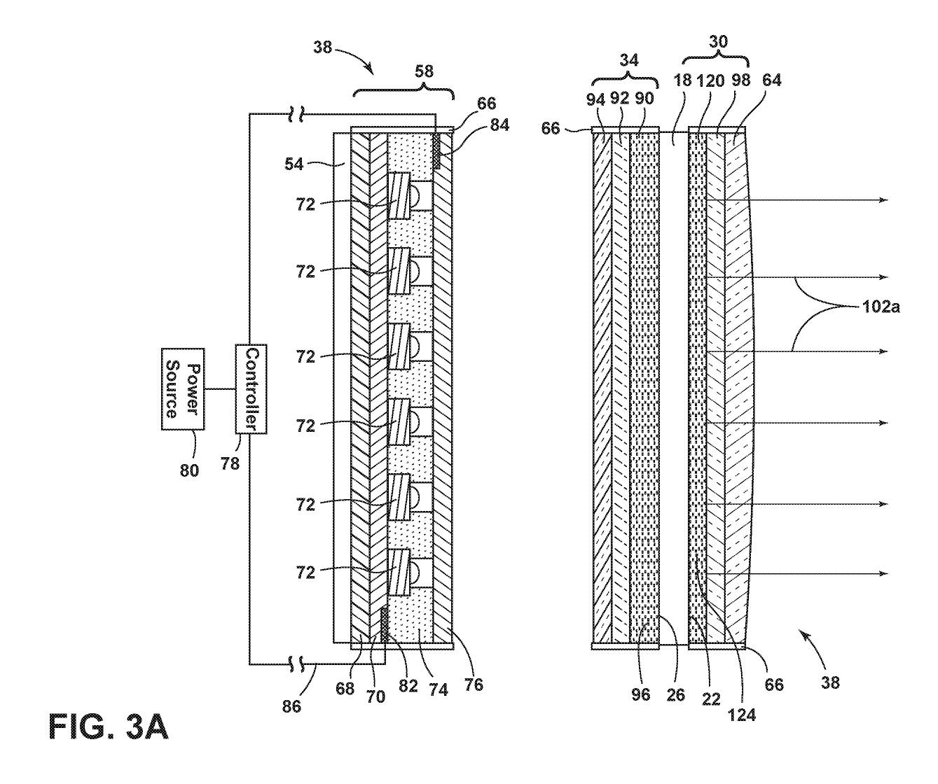

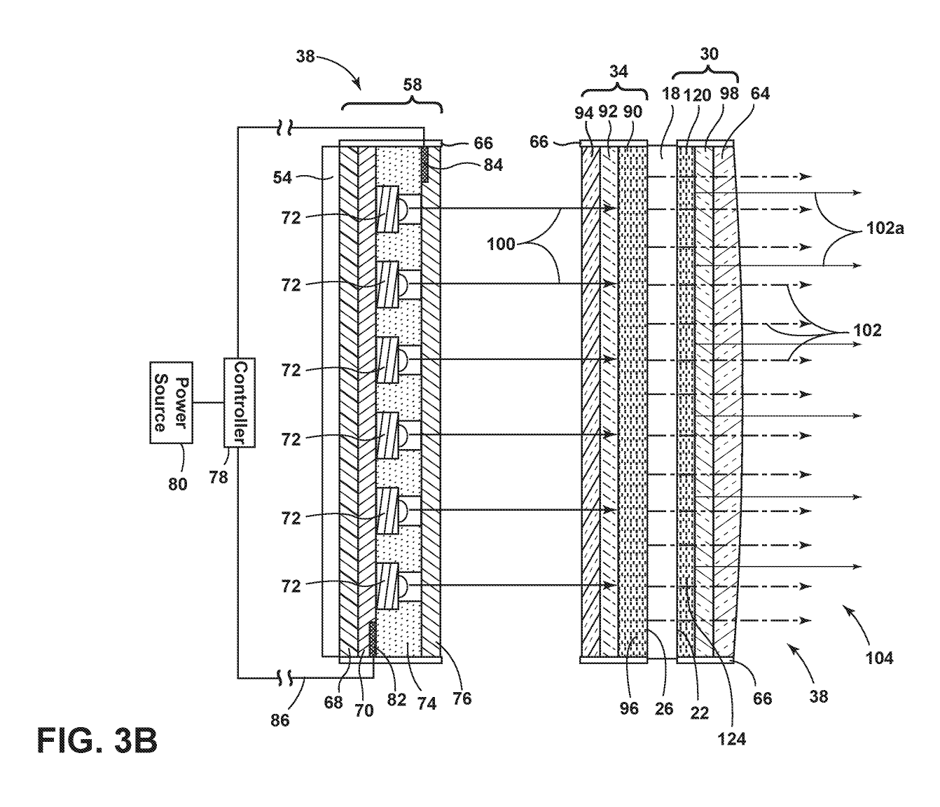

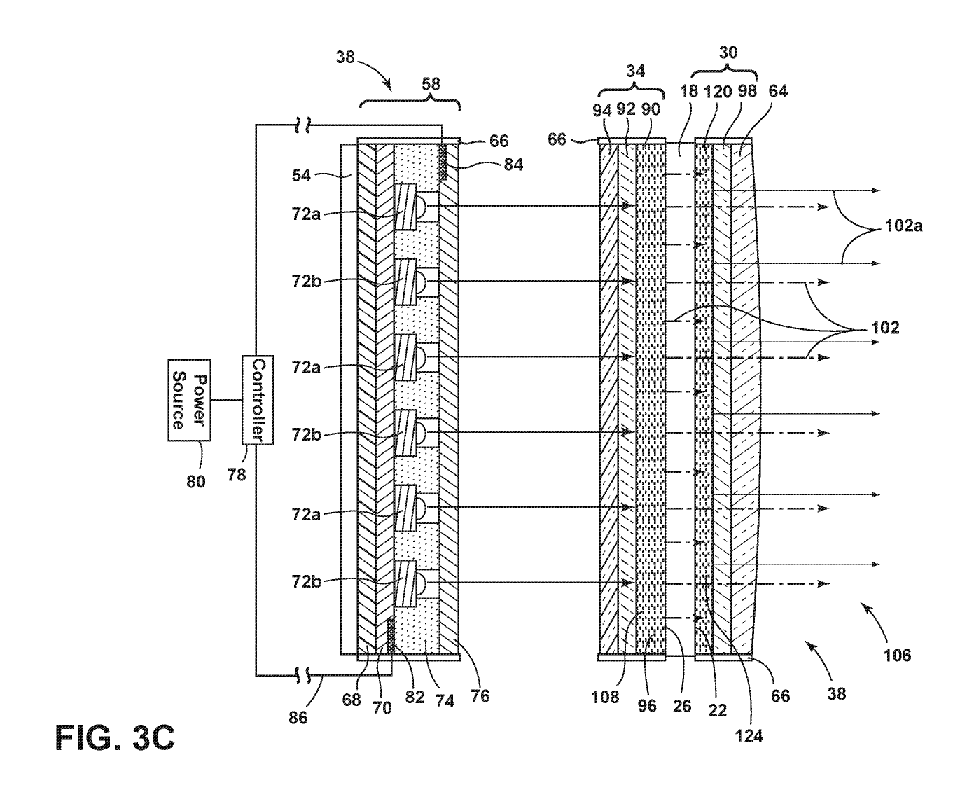

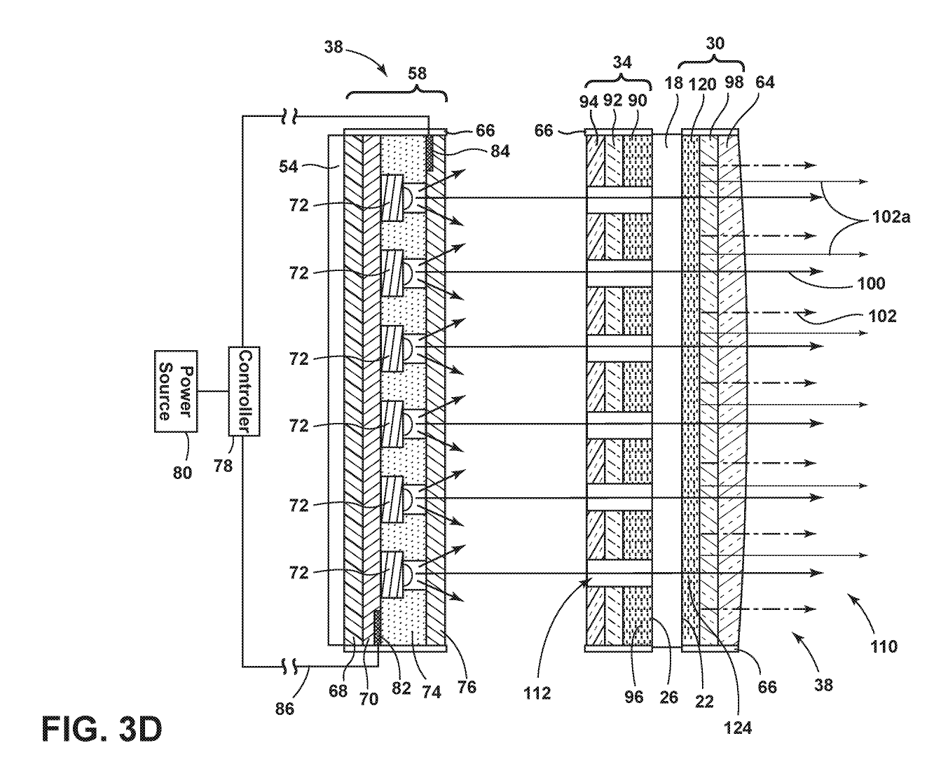

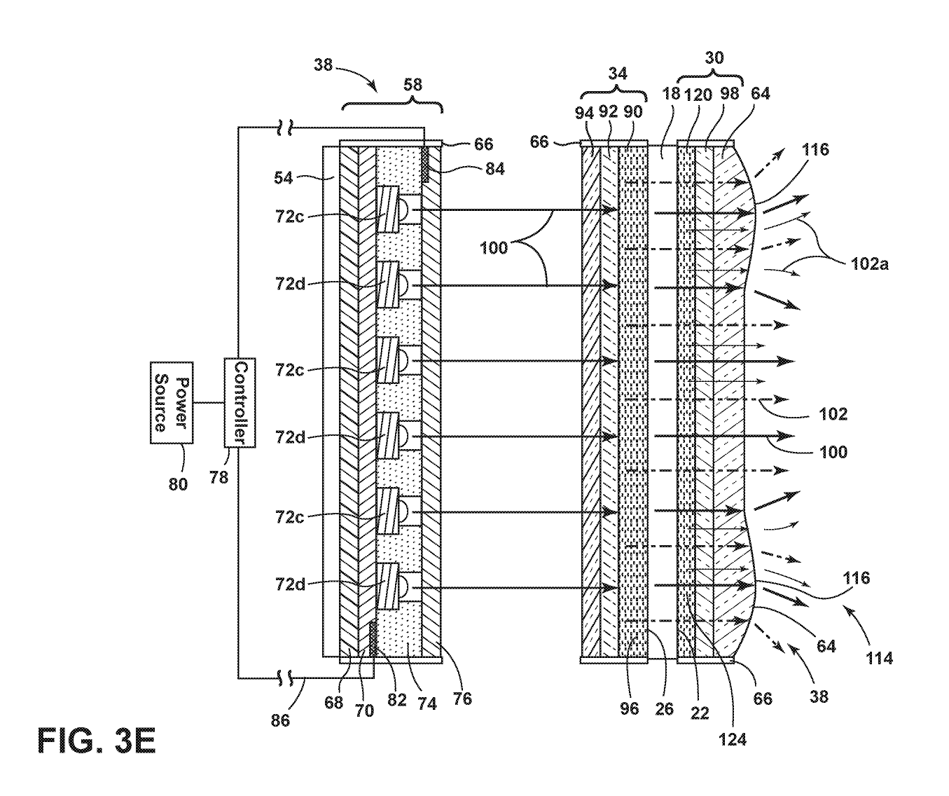

Referring to FIGS. 3A-3E, a cross-sectional view of the light-producing assembly 38 and the panel 14 is shown according to one embodiment. As illustrated in FIG. 3A, the light-producing assembly 38 may have a stacked arrangement that includes the PCB 54 and the light source 58. The light source 58 may take a variety of configurations such as one or more incandescent bulbs, electroluminescent fixtures and/or discrete light emitting diodes (LEDs). In the depicted embodiment, the light source 58 includes a printed LED assembly that may be applied in a continuous or semi-continuous manner. In printed LED assembly embodiments, the light source 58 may be applied to the PCB 54 in a pattern (e.g., stripes, dots, cross hatching, letters, symbols, and/or graphics) or may be applied as a large continuous structure such that the light source 58 may provide a uniform or non-uniform backlighting to the panel 14.

The light source 58 may correspond to a thin-film or printed LED assembly and includes a base member 68 as its lowermost layer. The base member 68 may include a polycarbonate, poly-methyl methacrylate (PMMA), or polyethylene terephthalate (PET) material, or any other material known in the art, on the order of 0.005 to 0.060 inches thick and is arranged over the intended vehicle 10 surface on which the light source 58 is to be received (e.g., PCB 54, an exterior panel, or the panel 14). Alternatively, as a cost saving measure, the base member 68 may directly correspond to a preexisting vehicle structure (e.g., the PCB 54, an exterior panel, or the panel 14).

The light source 58 includes a positive electrode 70 arranged over the base member 68. The positive electrode 70 includes a conductive epoxy such as, but not limited to, a silver-containing or copper-containing epoxy. The positive electrode 70 is electrically connected to at least a portion of a plurality of LED sources 72 arranged within a semiconductor ink 74 and applied over the positive electrode 70. Likewise, a negative electrode 76 is also electrically connected to at least a portion of the LED sources 72. The negative electrode 76 is arranged over the semiconductor ink 74 and includes a transparent or translucent conductive material such as, but not limited to, indium tin oxide. Additionally, each of the positive and negative electrodes 70, 76 are electrically connected to a controller 78 and a power source 80 via a corresponding bus bar 82, 84 and conductive leads 86, 88. The bus bars 82, 84 may be printed along opposite edges of the positive and negative electrodes 70, 76 and the points of connection between the bus bars 82, 84 and the conductive leads 86, 88 may be at opposite corners of each bus bar 82, 84 to promote uniform current distribution along the bus bars 82, 84. It should be appreciated that in alternate embodiments, the orientation of components within the light sources 58 may be altered without departing from the concepts of the present disclosure. For example, the negative electrode 76 may be disposed below the semiconductor ink 74 and the positive electrode 70 may be arranged over the aforementioned semiconductor ink 74. Likewise, additional components, such as the bus bars 82, 84 may also be placed in any orientation such that the light source 58 may emit inputted light 100 (FIG. 3B) towards a desired location (e.g., the photoluminescent structure 34 and/or the panel 14).

The LED sources 72 may be dispersed in a random or controlled fashion within the semiconductor ink 74 and may be configured to emit focused or non-focused light toward the photoluminescent structure 34. The LED sources 72 may correspond to micro-LEDs of gallium nitride elements on the order of about 5 to about 400 microns in size (e.g., diameter or longest dimension) and the semiconductor ink 74 may include various binders and dielectric material including, but not limited to, one or more of gallium, indium, silicon carbide, phosphorous, and/or translucent polymeric binders.

The semiconductor ink 74 can be applied through various printing processes, including ink jet and silk screen processes to selected portion(s) of the positive electrode 70. More specifically, it is envisioned that the LED sources 72 are dispersed within the semiconductor ink 74, and shaped and sized such that a substantial quantity of the LED sources 72 align with the positive and negative electrodes 70, 76 during deposition of the semiconductor ink 74. The portion of the LED sources 72 that ultimately are electrically connected to the positive and negative electrodes 70, 76 may be illuminated by a combination of the bus bars 82, 84, controller 78, power source 80, and conductive leads 86, 88. According to one embodiment, the power source 80 may correspond to a vehicular power source 80 operating at 12 to 16 VDC. Additional information regarding the construction of light-producing assemblies is disclosed in U.S. Patent Publication No. 2014/0264396 A1 to Lowenthal et al., entitled “ULTRA-THIN PRINTED LED LAYER REMOVED FROM SUBSTRATE,” filed Mar. 12, 2014, the entire disclosure of which is incorporated herein by reference.

Referring still to FIG. 3A, similarly to the printed LED embodiment of the light source 58, the photoluminescent structure 34 and the phosphorescent structure 30 may have a layered structure. The photoluminescent structure 34 is positioned on the B-surface 26 of the substrate 18 as a coating, layer, film or other suitable deposition and is spaced away from the negative electrode 76. In other embodiments, the photoluminescent structure 34 may be arranged over the negative electrode 76. With respect to the presently illustrated embodiment, the photoluminescent structure 34 may be arranged as a multi-layered structure including an energy conversion layer 90, optional stability layer 92, and optional protection layer 94. An optional coating or layer may be positioned between the photoluminescent structure 34 and the B-surface 26 of the substrate 18 or on stability layer 92 proximate the light-producing assembly 38.

The energy conversion layer 90 includes at least one photoluminescent material 96 having energy converting elements with phosphorescent or fluorescent properties. For example, the photoluminescent material 96 may include organic or inorganic fluorescent dyes including rylenes, xanthenes, porphyrins, phthalocyanines, or a combination thereof. Additionally, or alternatively, the photoluminescent material 96 may include phosphors from the group of Ce-doped garnets such as YAG:Ce. The energy conversion layer 90 may be prepared by dispersing the photoluminescent material 96 in a polymer matrix to form a homogenous mixture using a variety of methods. Such methods may include preparing the energy conversion layer 90 from a formulation in a liquid carrier medium and coating the energy conversion layer 90 to the negative electrode 76 or other desired base member 68. The photoluminescent structure 34 may be applied to the substrate 18 by painting, screen printing, flexography, spraying, slot coating, dip coating, roller coating, bar coating, and/or any other methods known in the art. Alternatively, the energy conversion layer 90 may be prepared by methods that do not use a liquid carrier medium. For example, the energy conversion layer 90 may be rendered by dispersing the photoluminescent material 96 into a solid state solution (homogenous mixture in a dry state) that may be incorporated in a polymer matrix formed by extrusion, injection seal, compression seal, calendaring, thermoforming, etc.

To protect the photoluminescent material 96 contained within the energy conversion layer 90 from photolytic and thermal degradation, the photoluminescent structure 34 may include the stability layer 92. The stability layer 92 may be configured as a separate layer optically coupled and adhered to the energy conversion layer 90 or otherwise integrated therewith. The photoluminescent structure 34 may also include the protection layer 94 optically coupled and adhered to the stability layer 92 or other layer (e.g., the energy conversion layer 90 in the absence of the stability layer 92) to protect the photoluminescent structure 34 from physical and chemical damage arising from environmental exposure. The stability layer 92 and/or the protection layer 94 may be combined with the energy conversion layer 90 through sequential coating or printing of each layer, sequential lamination or embossing, or any other suitable means. Additional information regarding the construction of photoluminescent structures is disclosed in U.S. Pat. No. 8,232,533 to Kingsley et al., entitled “PHOTOLYTICALLY AND ENVIRONMENTALLY STABLE MULTILAYER STRUCTURE FOR HIGH EFFICIENCY ELECTROMAGNETIC ENERGY CONVERSION AND SUSTAINED SECONDARY EMISSION,” filed Nov. 8, 2011, the entire disclosure of which is incorporated herein by reference.

In operation, the photoluminescent material 96 is formulated to become excited upon receiving inputted light 100 (FIGS. 2 and 3B) of a specific wavelength from at least a portion of the LED sources 72 of the light source 58. As a result, the inputted light 100 undergoes an energy conversion process and is re-emitted at a different wavelength. According to one embodiment, the photoluminescent material 96 may be formulated to convert inputted light 100 into a longer wavelength light, otherwise known as down conversion. Alternatively, the photoluminescent material 96 may be formulated to convert inputted light 100 into a shorter wavelength light, otherwise known as up conversion. Under either approach, light converted by the photoluminescent material 96 may be immediately converted to outputted light 102 (FIG. 3B) from the photoluminescent structure 34 or otherwise used in an energy cascade, wherein the converted light serves as inputted light to excite another formulation of photoluminescent material 96 located within the energy conversion layer 90, whereby the subsequent converted light may then be outputted from the photoluminescent structure 34 or used as inputted light, and so on. Additionally or alternatively, the outputted light 102 may be used to excite the phosphorescent structure 30. With respect to the energy conversion processes described herein, the difference in wavelength between the inputted light 100 and the converted outputted light 102 is known as the Stokes shift and serves as the principle driving mechanism for an energy conversion process corresponding to a change in wavelength of light. The outputted light 102 may be of such a wavelength that it does not interact with the substrate 18 and/or phosphorescent structure 30 and may pass through substantially unimpeded. The outputted light 102 may also, at least partially, be used to charge the phosphorescent structure 30, in addition to, or alternatively from, ambient light sources.

Positioned on the A-surface 22 of the substrate 18 is the phosphorescent structure 30. The phosphorescent structure 30 may be a multi-layered structure, similar to that of the photoluminescent structure 34. In the depicted embodiment, the phosphorescent structure 30 may include a phosphorescent layer 120, a decorative layer 98, and a viewable portion 64. It will be understood that the phosphorescent structure 30 may only include the phosphorescent layer 120 without departing from the spirit of this disclosure. The phosphorescent layer 120 may be prepared by dispersing one or more phosphorescent materials 124 in a polymer matrix to form a homogenous mixture using a variety of methods. Such methods may include preparing the phosphorescent layer 120 from a formulation in a liquid carrier medium and coating the phosphorescent layer 120 to the substrate 18 or other desired surface. Alternatively, the phosphorescent layer 120 may be prepared by methods that do not use a liquid carrier medium. For example, the phosphorescent layer 120 may be rendered by dispersing the phosphorescent material 124 into a solid state solution (homogenous mixture in a dry state) that may be incorporated in a polymer matrix formed by extrusion, injection seal, compression seal, calendaring, thermoforming, etc. The phosphorescent structure 30 may be applied to the substrate 18 by painting, screen printing, flexography, spraying, slot coating, dip coating, roller coating, bar coating, and/or any other methods known in the art. The phosphorescent structure 30 may be formed in a similar manner to that of the photoluminescent structure 34 (e.g., ink jet and/or silk screen processes).

The phosphorescent structure 30 may include one or more phosphorescent materials 124 configured to emit light once charged by ambient lighting proximate the panel 14 (e.g., lights in the vehicle 10, the sun and/or other natural or artificial sources), the outputted light 102 and/or the inputted light 100. In various embodiments, the phosphorescent materials 124 may include one or more persistent phosphor(s). The persistent phosphorescent materials 124 may be defined as being operable to carry a charge and discharge light for a period after charging. For example, persistent phosphorescent materials 124, as described herein, may have an afterglow decay time ranging from several minutes to tens of hours. The decay time may be defined as the time between the end of the excitation or charging and the moment when the light intensity of the phosphorescent material 124 drops below a minimum visibility of 0.32 mcd/m². A visibility of 0.32 mcd/m² is roughly 100 times the sensitivity of the dark-adapted human eye, which corresponds to a definition used by persons of ordinary skill in the art.

The persistent phosphorescent material 124, according to one embodiment, may be operable to emit light at an intensity of 0.32 mcd/m² after a period of 10 minutes. In an exemplary embodiment, the persistent phosphorescent material 124 may be operable to emit light at an intensity of 0.32 mcd/m² after a period of 30 minutes and, in some embodiments, for a period longer than 60 minutes.

The persistent phosphorescent materials 124 may be operable to store energy received from an activation emission (e.g., ambient light, the inputted light 100 and/or outputted light 102) or a corresponding wavelength. The stored energy may then be emitted from the persistent phosphorescent material 124 as phosphorescent light 102a for a wide range of times, some extending up to approximately 24 hours. Such materials, when utilized with the panel 14, described herein, may make it possible for the phosphorescent structure 30 to continually illuminate through a plurality of excitation sources, including, but not limited to, ambient light, the light source 58 within the light-producing assembly 38, and/or the outputted light 102 from the photoluminescent structure 34. The periodic absorption of activation emission from the excitation sources may provide for a substantially sustained charge of the persistent phosphorescent materials 124 to provide for a consistent ambient illumination. For example, the light-producing assembly 38 may be pulsed, or otherwise periodically be activated to charge the phosphorescent structure 30 such that the phosphorescent structure 30 provides a constant or changing level of emitted phosphorescent light 102a.

The persistent phosphorescent materials 124 may correspond to alkaline earth aluminates and silicates, for example doped (di)silicates, or any other compound that is capable of emitting light for a period of time once an inputted light is no longer present. Such substances may incorporate persistent phosphorescent phosphors or other doped compounds. The persistent phosphorescent materials 124 may be doped with one or more ions, which may correspond to rare earth elements, for example: Eu²⁺, Tb³⁻ and/or Dy³⁺. According to one non-limiting exemplary embodiment, the phosphorescent structure 30 includes phosphorescent material 124 in the range of about 30% to about 55%, a liquid carrier medium in the range of about 25% to about 55%, a polymeric resin in the range of about 15% to about 35%, a stabilizing additive in the range of about 0.25% to about 20%, and performance-enhancing additives in the range of about 0% to about 5%, each based on the weight of the formulation. The phosphorescent materials 124 may have an average particle diameter of between about 1μ and about 100μ, between about 5μ and about 50μ, or between about 10μ and about 30μ. The phosphorescent materials 124 may have an excitation wavelength of between about 10 nm and about 700 nm.

According to one embodiment, the phosphorescent structure 30 is a translucent white color when unilluminated. Once the phosphorescent structure 30 receives the activation emission of a necessary wavelength, the phosphorescent structure 30 may emit the phosphorescent light 102a as blue light therefrom. The light emitted from the phosphorescent structure 30 may be of a desired brightness such that any indicia within the viewable portion 64 is perceptible, but not so bright that an onlooker could not perceive a pattern of the indicia. According to one embodiment, the blue emitting phosphorescent material 124 may be Li₂ZnGeO₄ and may be prepared by a high temperature solid-state reaction method. The blue afterglow may last for a duration of five to eight hours which may originate from an activation emission and d-d transitions of Mn²⁻ ions.

According to an alternate non-limiting exemplary embodiment, 100 parts of a commercial solvent-borne polyurethane, such as Mace resin 107-268, having 50% solids polyurethane in Toluene/Isopropanol, 125 parts of a blue green long persistent phosphor, such as Performance Indicator PI-BG20, and 12.5 parts of a dye solution containing 0.1% Lumogen Yellow F083 in dioxolane may be blended to yield a low rare earth mineral phosphorescent structure 30. It will be understood that the compositions provided herein are non-limiting examples. Thus, any phosphor known in the art may be utilized for utilization as a phosphorescent structure 30 without departing from the teachings provided herein. Moreover, it is contemplated that any long persistent phosphor known in the art may also be utilized without departing from the teachings provided herein.

Additional information regarding the production of long persistence luminescent materials is disclosed in U.S. Pat. No. 8,163,201 to Agrawal et al., entitled “HIGH-INTENSITY, PERSISTENT PHOTOLUMINESCENT FORMULATIONS AND OBJECTS, AND METHODS FOR CREATING THE SAME,” issued Apr. 24, 2012, the entire disclosure of which is incorporated herein by reference. For additional information regarding long persistent phosphorescent structures, refer to U.S. Pat. No. 6,953,536 to Yen et al., entitled “LONG PERSISTENT PHOSPHORS AND PERSISTENT ENERGY TRANSFER TECHNIQUE,” issued Oct. 11, 2005; U.S. Pat. No. 6,117,362 to Yen et al., entitled “LONG-PERSISTENCE BLUE PHOSPHORS,” issued Sep. 12, 2000; and U.S. Pat. No. 8,952,341 to Kingsley et al., entitled “LOW RARE EARTH MINERAL PHOTOLUMINESCENT COMPOSITIONS AND STRUCTURES FOR GENERATING LONG-PERSISTENT LUMINESCENCE,” issued Feb. 10, 2015, all of which are incorporated herein by reference in their entirety.

With continued reference to FIG. 3A, the viewable portion 64 is arranged over the decorative layer 98. In some embodiments, the viewable portion 64 may include a plastic, silicon, or urethane material and is molded over the phosphorescent structure 30. Preferably, the viewable portion 64 should be at least partially light transmissible. In this manner, the viewable portion 64 will be illuminated by the phosphorescent layer 120, the photoluminescent structure 34 and/or the light-producing assembly 38 when active. Additionally, by over-sealing the viewable portion 64, it may also function to protect the phosphorescent structure 30. The viewable portion 64 may be arranged in a planar shape and/or an arcuate shape to enhance its viewing potential when in a luminescent state. Like the photoluminescent structure 34 and the light source 58, the viewable portion 64 and phosphorescent structure 30 may also benefit from a thin design, thereby helping to fit into small package spaces of the vehicle 10. Additionally or alternatively, the viewable portion 64 may define or contribute to the formation of the indicia 50.

In some embodiments, the decorative layer 98 may be disposed between the viewable portion 64 and the phosphorescent layer 120. The decorative layer 98 may include a polymeric material or other suitable material and is configured to control or modify an appearance of the viewable portion 64. For example, the decorative layer 98 may be configured to confer a leather appearance to the viewable portion 64 when the viewable portion 64 is in an unilluminated state. In other embodiments, the decorative layer 98 may be tinted any color to complement the vehicle structure on which the phosphorescent structure 30 is to be received. For example, the decorative layer 98 may be similar in color to that of the panel 14 so that the phosphorescent structure 30 is substantially hidden when in the unilluminated state. Alternatively, the decorative layer 98 may provide indicia 50 and/or an emblem such that the decorative layer 98 and the indicia 50 may be backlit and/or otherwise illuminated by the light-producing assembly 38. In any event, the decorative layer 98 should be at least partially light transmissible such that the photoluminescent structure 34 and phosphorescent structure 30 are not prevented from illuminating the viewable portion 64 whenever an energy conversion process is underway.

The overmold material 66 is disposed around the light sources 58, photoluminescent structure 34 and/or phosphorescent structure 30. The overmold material 66 may be formed integrally with the viewable portion 64 or any layer of the light sources 58, photoluminescent structure 34 and/or phosphorescent structure 30. The overmold material 66 may protect the light-producing assembly 38, phosphorescent structure 30, and photoluminescent structure 34 from a physical and chemical damage arising from environmental exposure. The overmold material 66 may have viscoelasticity (i.e., having both viscosity and elasticity), a low Young's modulus, and/or a high failure strain compared with other materials so that the overmold material 66 may protect the light-producing assembly 38, phosphorescent structure 30 and/or photoluminescent structure 34 when contact is made thereto. For example, the overmold material 66 may protect the phosphorescent structure 30 from the repetitive contact that may occur when occupants of the vehicle 10 contact the panel 14. It should be appreciated that the viewable portion 64 and the overmold material 66 may be two separate components, or may be integrally formed as a single component.

Referring to FIG. 3B, an energy conversion process 104 for producing single color luminescence is illustrated according to one embodiment. In this embodiment, the energy conversion layer 90 of the photoluminescent structure 34 includes a single photoluminescent material 96, which is configured to convert the inputted light 100 received from LED sources 72 into an outputted light 102 having a wavelength different than that associated with the inputted light 100. More specifically, the photoluminescent material 96 is formulated to have an absorption spectrum that includes the emission wavelength of the inputted light 100 supplied from the LED sources 72. The photoluminescent material 96 is also formulated to have a Stokes shift resulting in the converted visible outputted light 102 having an emission spectrum expressed in a desired color, which may vary per lighting application. The converted visible outputted light 102 is outputted from the light source 58 via the viewable portion 64, thereby causing the viewable portion 64 to illuminate in the desired color. In one embodiment, the energy conversion process 104 is undertaken by way of down conversion, whereby the inputted light 100 includes light on the lower end of the visibility spectrum such as blue, violet, or ultraviolet (UV) light. Doing so enables blue, violet, or UV LEDs to be used as the LED sources 72, which may offer a relative cost advantage over simply using LEDs of the desired color and foregoing the energy conversion process altogether. Furthermore, the illumination provided by the viewable portion 64 may offer a unique, substantially uniform, and/or attractive viewing experience that may be difficult to duplicate through non-photoluminescent means. The outputted light 102 may be used to excite or charge the phosphorescent structure 30, perform color mixing with the phosphorescent light 102a, or may not interact with the phosphorescent structure 30.

Referring to FIG. 3C, a second energy conversion process 106 for generating multiple colors of light is illustrated according to one embodiment. For consistency, the second energy conversion process 106 is also described below using the light-producing assembly 38 depicted in FIG. 3A. In this embodiment, the energy conversion layer 90 includes first and second photoluminescent materials 96, 108 that are interspersed within the energy conversion layer 90. Alternatively, the photoluminescent materials 96, 108 may be isolated from each other if desired (e.g. to form a pattern). Also, it should be appreciated that the energy conversion layer 90 may include more than two different photoluminescent materials 96, 108, in which case, the concepts provided herein similarly apply. In one embodiment, the second energy conversion process 106 occurs by way of down conversion using blue, violet, and/or UV light as the source of excitation.

With respect to the presently illustrated embodiment, the excitation of photoluminescent materials 96, 108 is mutually exclusive. That is, photoluminescent materials 96, 108 are formulated to have non-overlapping absorption spectrums and Stoke shifts that yield different emission spectrums. Also, in formulating the photoluminescent materials 96, 108, care should be taken in choosing the associated Stoke shifts such that the converted outputted light 102 emitted from one of the photoluminescent materials 96, 108, does not excite the other, unless so desired. According to one exemplary embodiment, a first portion of the LED sources 72, exemplarily shown as LED sources 72a, is configured to emit an inputted light 100 having an emission wavelength that only excites photoluminescent material 96 and results in the inputted light 100 being converted into a visible light outputted 102 of a first color (e.g., white). Likewise, a second portion of the LED sources 72, exemplarily shown as LED sources 72b, is configured to emit an inputted light 100 having an emission wavelength that only excites second photoluminescent material 108 and results in the inputted light 100 being converted into a visible outputted light 102 of a second color (e.g., red). Preferably, the first and second colors are visually distinguishable from one another. In this manner, LED sources 72a and 72b may be selectively activated using the controller 78 to cause the photoluminescent structure 34 to luminesce in a variety of colors. For example, the controller 78 may activate only LED sources 72a to exclusively excite photoluminescent material 96, resulting in the viewable portion 64 illuminating in the first color. Alternatively, the controller 78 may activate only LED sources 72b to exclusively excite the second photoluminescent material 108, resulting in the viewable portion 64 illuminating in the second color. Similarly, by choice of the photoluminescent materials 96, 108, emission from one, both, or neither of the photoluminescent materials 96, 108 may result in activation of the phosphorescent structure 30.

Alternatively still, the controller 78 may activate LED sources 72a and 72b in concert, which causes both of the photoluminescent materials 96, 108 to become excited, resulting in the viewable portion 64 illuminating in a third color, which is a color mixture of the first and second color (e.g., pinkish). The intensities of the inputted light 100 emitted from each light source 72a, 72b may also be proportionally varied to one another such that additional colors may be obtained. For energy conversion layers 90 containing more than two distinct photoluminescent materials 96, 108, a greater diversity of colors may be achieved. Contemplated colors include red, green, blue, and combinations thereof, including white, all of which may be achieved by selecting the appropriate photoluminescent materials 96, 108 and correctly manipulating their corresponding LED sources 72. The controller 78 may be configured to take into account the color of the phosphorescent light 102a when activating the light source 72a, 72b such that proper color mixing or activation of the phosphorescent structure 30 may be accomplished.

Referring to FIG. 3D, a third energy conversion process 110 includes the light-producing assembly 38 and the photoluminescent structure 34. The photoluminescent structure 34 is configured to convert inputted light 100 received from LED sources 72 into a visible outputted light 102 having a wavelength different than that associated with the inputted light 100. More specifically, the photoluminescent structure 34 is formulated to have an absorption spectrum that includes the emission wavelength of the inputted light 100 supplied from the LED sources 72. The photoluminescent material 96 is also formulated to have a Stokes shift resulting in the converted visible outputted light 102 having an emission spectrum expressed in a desired color, which may vary per lighting application.

The photoluminescent structure 34 may be applied to only a portion of the panel 14, for example, in a stripped manner. Between the photoluminescent structures 34 may be light transmissive portions 112 that allow inputted light 100 emitted from the LED sources 72 to pass therethrough at the first wavelength. The light transmissive portions 112 may be an open space, or may be a transparent or translucent material. The inputted light 100 emitted through the light transmissive portions 112 may be directed from light-producing assembly 38 towards a second photoluminescent structure or the phosphorescent structure 30. The inputted light 100 may activate the phosphorescent structure 30, pass through the phosphorescent structure 30 or both.

Referring to FIG. 3E, a fourth energy conversion process 114 for generating multiple colors of light utilizing the light-producing assembly 38 is depicted. The excitation of photoluminescent material 96 is configured such that a portion of inputted light 100 emitted from the LED sources 72 passes through the photoluminescent structure 34 at the first wavelength (i.e., the inputted light 100 emitted from the light source 58 is not converted by the photoluminescent structure 34). The intensity of the emitted inputted light 100 may be modified by pulse-width modulation or current control to vary the amount of inputted light 100 emitted from the LED sources 72 that passes through the photoluminescent structure 34 without converting to the outputted light 102 wavelength. For example, if the light-producing assembly 38 is configured to emit inputted light 100 at a low level, substantially all of the inputted light 100 may be converted to the second wavelength of outputted light 102. In this configuration, a color of outputted light 102 corresponding to the photoluminescent structure 34 may be transmitted through the substrate 18. If the light-producing assembly 38 is configured to emit inputted light 100 at a high level, only a portion of the first wavelength may be converted by the photoluminescent structure 34. In this configuration, a first portion of the inputted light 100 may be converted by the photoluminescent structure 34 and a second portion of the inputted light 100 may be transmitted through the substrate 18 at the first wavelength towards additional photoluminescent structures 34 disposed proximately to the light-producing assembly 38 and/or to the phosphorescent structure 30. The additional photoluminescent structures 34 or the phosphorescent structure 30 may luminesce in response to the inputted light 100 emitted from the light source 58.

According to one exemplary embodiment, a first portion of the LED sources 72, exemplarily shown as LED sources 72c is configured to emit an inputted light 100 having a wavelength that excites the photoluminescent material 96 within the photoluminescent structure 34 and results in the inputted light 100 being converted into a visible outputted light 102 of a first color (e.g., white). Likewise, a second portion of the LED sources 72, exemplarily shown as LED sources 72d, is configured to emit an inputted light 100 having a wavelength that passes through the photoluminescent structure 34 and excites additional photoluminescent structures or the photoluminescent structure 34 thereby illuminating in a second color. The first and second colors may be visually distinguishable from one another. In this manner, LED sources 72c and 72d may be selectively activated using the controller 78 to cause the panel 14 to luminesce in a variety of colors.

The viewable portion 64 of the phosphorescent structure 30 may also include optics 116 that are configured to direct inputted light 100 emitted from the LED sources 72c, 72d, the outputted light 102 emitted from the photoluminescent structure 34 and/or phosphorescent structure 30 towards pre-defined locations. For example, the inputted light 100 emitted from the LED sources 72c, 72d, the outputted light 102 from the photoluminescent structure 34 and/or phosphorescent structure 30 may be directed and/or focused towards a desired feature and/or location proximate to the panel 14 (e.g., a handle).

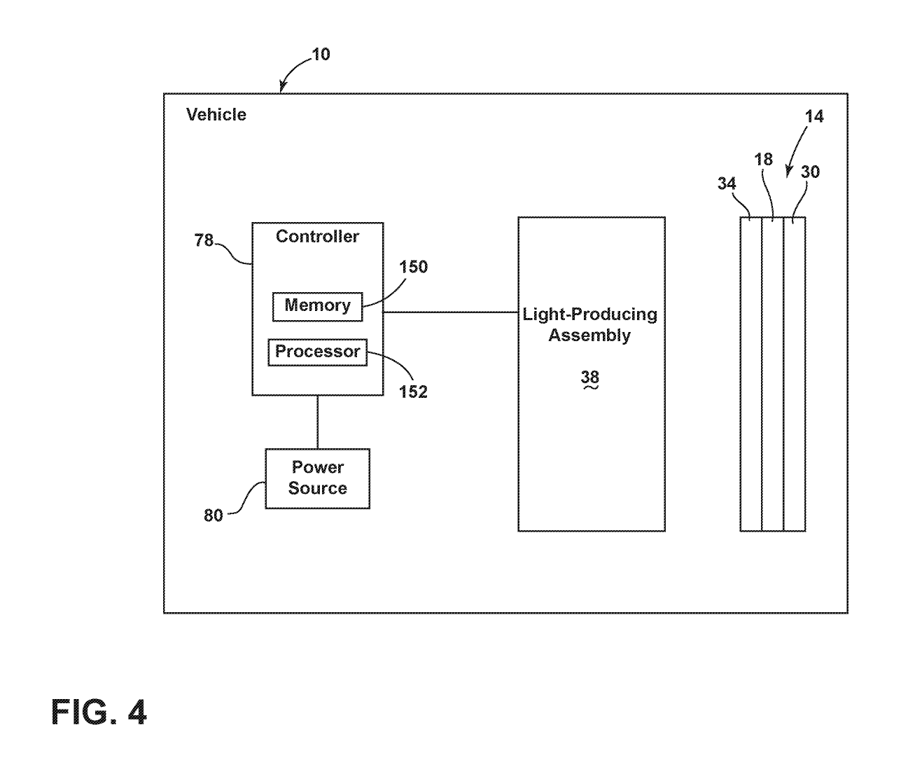

Referring now to FIG. 4, a box diagram of the vehicle 10 is shown in which the panel 14 and light-producing assembly 38 are implemented. The vehicle 10 includes the controller 78 in communication with the light-producing assembly 38. The controller 78 may include a memory 150 having instructions contained therein that are executed by a processor 152 of the controller 78. The controller 78 may provide electrical power to the light-producing assembly 38 via the power source 80 located onboard the vehicle 10. In addition, the controller 78 may be configured to control the light output of the light-producing assembly 38 based on feedback received from one or more vehicle control modules. The control module 78 may be configured to operate the LED sources 72, the first portion of LEDs 72a and/or the second portion of LEDs 72b separately and/or in an alternating manner (e.g., via current direction manipulation) in order to achieve a specific lighting appearance for the panel 14. For example, one or more of the LED sources 72, the first portion of LEDs 72a and/or the second portion of LEDs 72b may be configured to activate excite the photoluminescent structure 34, the phosphorescent structure 30 or both. In some embodiments, the light-producing assembly 38 may be operated such that portions of the light-producing assembly 38 are activated and other portions are not such that the panel 14 appears to be multicolored, has a pulsing effect, a specific feature (e.g., the indicia 50) is/isn't illuminated and/or has a gradient to the color or intensity of light. By activating the light-producing assembly 38, the color of the illumination from the panel 14 may change from a first color (e.g., the color of the phosphorescent structure 30) to a second color (e.g., colors emitted by the photoluminescent structure 34, the LED sources 72, the phosphorescent structure 30 and/or combinations thereof). The change in color of the panel 14 may serve to communicate information (e.g., speed, engine RPM, fluid levels), provide aesthetic lighting (e.g., pulse with music, provide warm ambient lighting, pulse with a sensed heartbeat) or to provide large area ambient illumination to the interior 46 of the vehicle 10. Further, the controller 78 may be configured to pulse the light-producing assembly 38 such that the phosphorescent structure 30 may keep a predetermined level of charge and luminance.

Use of the panel 14 and the light-producing assembly 38, as described herein, may offer several advantages. For example, use of the panel 14 may allow for the ambient lighting of a large area of the interior 46 of the vehicle 10, or for the highlighting of specific features of the panel 14 (e.g., handle, buttons, arm rests, door locks, aesthetic features). Additionally or alternatively, the panel 14 may be applied as a strip within the interior 46 of the vehicle 10. Another advantage that may be realized is that the panel 14 may not need to be electrically connected to the power source 80 to provide illumination. By utilizing the long persistent phosphor structure 30, lighting may be achieved without a resulting drain on a battery of the vehicle 10. Additionally, by activating the photoluminescent structure 34 by the remotely placed light-producing assembly 38, the panel 14 itself may not have an electrical connection. Further, utilizing the light-producing assembly 38 and the photoluminescent structure 34, a smaller light-producing assembly 38 may be used to the smoothing, or evening effect of the photoluminescent structure 34.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A vehicle, comprising:
a panel, comprising:
a substrate defining a first surface and a second surface disposed on opposite sides thereof;
a phosphorescent structure positioned on the first surface of the substrate; and
a photoluminescent structure positioned on the second surface of the substrate; and
a light-producing assembly positioned to illuminate the second surface of the substrate.

2. The vehicle of claim 1, wherein the substrate defines a substantially translucent portion.

3. The vehicle of claim 1, wherein the light emitted from the light-producing assembly is configured to excite the photoluminescent structure.

4. The vehicle of claim 3, wherein light emitted from the excitation of the photoluminescent structure is configured to be transmitted through the substrate.

5. The vehicle of claim 4, wherein the light-producing assembly comprises a printed circuit board with a light source disposed thereon and the first surface is an A-surface of the substrate and the second surface is a B-surface of the substrate.

6. The vehicle of claim 2, wherein the phosphorescent structure is positioned over at least a portion of the translucent portion.

7. The vehicle of claim 1, wherein the panel is configured to be front lit by the phosphorescent structure and backlit by the photoluminescent structure.

8. A vehicle, comprising:
a vehicle interior panel, comprising:
a substrate defining an A-surface and a B-surface disposed on opposite sides thereof; and
a photoluminescent structure positioned on the B-surface of the substrate; and
a light-producing assembly positioned proximate the B-surface of the substrate, wherein the light-producing assembly is configured to emit light toward the photoluminescent structure.

9. The vehicle of claim 8, wherein the substrate defines a substantially translucent portion.

10. The vehicle of claim 9, further comprising:
a phosphorescent structure, the phosphorescent structure disposed on the A-surface.

11. The vehicle of claim 10, wherein the phosphorescent structure is positioned over at least a portion of the translucent portion.

12. The vehicle of claim 10, wherein the panel is configured to be front lit by the phosphorescent structure and backlit by the photoluminescent structure.

13. The vehicle of claim 9, wherein the translucent portion includes an indicia.

14. The vehicle of claim 8, wherein the light-producing assembly comprises a printed circuit board with a printed LED assembly thereon.

15. A vehicle, comprising:
an interior panel comprising a substrate, wherein the substrate includes at least one substantially translucent portion; and
a light-producing assembly positioned outboard of the interior panel, wherein the light-producing assembly is configured to emit light toward an outboard surface of the substrate.

16. The vehicle of claim 15, further comprising:
a phosphorescent structure, wherein the phosphorescent structure is positioned on an inboard surface of the substrate.

17. The vehicle of claim 15, further comprising:
a photoluminescent structure, wherein the photoluminescent structure is positioned on the outboard surface of the substrate.

18. The vehicle of claim 17, wherein the light emitted from the light-producing assembly is configured to excite the photoluminescent structure to output light, further wherein the outputted light from the photoluminescent structure is configured to pass through the substrate.

19. The vehicle of claim 16, wherein the phosphorescent structure is positioned over at least a portion of the translucent portion.

20. The vehicle of claim 18, wherein the light-producing assembly comprises a printed circuit board and a printed LED assembly.
